(19) United States
(12) Patent Application Publication
(10) Pub. No.: US 2018/0009722 A1
(43) Pub. Date: Jan. 11, 2018

(54) GRAPHENE BASED GROWING MEDIUM AND METHOD

(71) Applicant: Gordon CHIU, Summit, NJ (US)

(72) Inventor: Gordon CHIU, Summit, NJ (US)

(21) Appl. No.: 15/645,493

(22) Filed: Jul. 10, 2017

Related U.S. Application Data
(60) Provisional application No. 62/359,949, filed on Jul. 8, 2016.

(51) Int. Cl. C05G 3/04; C05B 17/00; C05D 9/02; C09K 17/02

(52) U.S. Cl. CPC C05G 3/04; C09K 17/02; C05B 17/00; C05D 9/02

(57) ABSTRACT

The present invention provides for a growing medium having a mix of soil, graphene, and/or graphene oxide. In at least one example, soil is combined with single or few layer graphene. In another example, the soil is combined with single or few layer graphene, including graphene sheets, and graphene oxide. The growing medium has been shown to increase plant growth while providing for growing medium aeration, increased water retention, and increased nutrient loading and release.

### CLAIM OF PRIORITY

This application claims the priority of U.S. Ser. No. 62/359,949 filed on Jul. 8, 2016, the contents of which are fully incorporated herein by reference.

### FIELD OF THE EMBODIMENTS

The field of the embodiments of the present invention relate to growing mediums and methods for horticultural endeavors, in particular, growing mediums that have some content of graphene and/or graphene oxide.

### BACKGROUND OF THE EMBODIMENTS

Graphene is an allotrope of carbon in the form of a two-dimensional, atomic-scale, lattice in which one carbon atom forms each vertex of the lattice structure. Graphene comprises the basic structural element of other allotropes of carbon, including but not limited, to graphite, charcoal, nanotubes, nanofibers, and fullerenes. Graphene may also be considered to be an indefinitely large aromatic molecule or aromatic hydrocarbon.

Graphene has many extraordinary properties which makes it desirable for further investigation, research, and use. It is about on hundred times stronger than the strongest currently known steel. Further, graphene conducts heat and electricity with great efficiently and is nearly transparent. Graphene also displays a large and nonlinear diamagnetism, even greater than graphite, and as a result can even be levitated by some magnets.

Graphene oxide, also known in some circles as graphitic oxide or graphitic acid, is a compound of carbon, oxygen, and hydrogen in variable ratios. Graphene oxide may be obtained by treating graphite with a variety of known oxidizers. The maximally oxidized product takes the form of a yellow solid with C:O ratio between about 2.1 and about 2.9. Such a structure still retains the layer structure of graphite but contains a substantially larger and more irregular spacing. As a result, graphene oxide has a large amount of oxygen-containing functional groups and great surface area and it exhibits an affinity for the absorption of contaminants. Thus, it may have practical uses in restoring contaminated soil thereby boosting vegetation growth.

In modern agricultural, there is an imminent need to meet the needs of a rising global population. Already methods are underway to strategize how best to use arable land for farming and production of food stock plants. However, this is but one of many problems agriculture needs to address. Another major need in the agricultural industry is the ability to promote plant growth while reducing the cost associated with growing and sustaining the plant.

Slow-release fertilizers, such as nutrients coated with thin layer of hydrophobic material, can make the fertilizer more effective and therefore applied less often. However, there are still certain shortcomings existing in slow-release fertilizers, such as the nutrients mainly being manifested in a relatively fixed proportion.

Thus, there is a need for a growing medium that provides at least increased plant growth while further providing medium filtration, increased nutrient loading and release, and increased water retention. The present invention and its embodiments meet and exceeds these objectives.

### Review of Related Technology:

U.S. Patent Application 2010/0158612 pertains to methods of remediating soil, sediment or water contaminated with organic compounds such as polychlorinated biphenyls or nitro-aromatic compounds are provided which involve combining the soil, sediment or water with a graphitic carbon and a reducing agent. The contaminants are converted to substances having an increased propensity to enter into an aqueous phase and/or undergo further degradation via biological oxidation.

International Application W02013/147396 pertains to a soil composition for water treatment and a use thereof. More particularly, a soil composition for biological, chemical and physical treatment of wastewater which includes a soil, a radical generator, and an adsorbent and a use thereof are disclosed. The soil composition may have microbiological, chemical and physical treatment effects. In addition, the soil composition is relatively inexpensive and does not require separate equipment investment and thus is economical. Furthermore, the soil composition may be applied to various treatment processes according to objects to be treated.

Chinese Patent 104119149 pertains to compound fertilizers, in particular to a coated slow-release compound fertilizer containing oxidized graphene. The fertilizer is prepared from the following raw materials in parts by weight: 10-15 parts of 1,250-2,000-mesh diatomite, 0.1-0.2 part of gibberellins, 20-24 parts of potassium dihydrogen phosphate, 10-12 parts of silkworm excrement, 8-10 parts of sawdust, 15-18 parts of diphosphorus pentoxide, 6-8 parts of sodium polyaspartate, 10-12 parts of a calcium magnesium phosphate fertilizer, 8-12 parts of peat soil, 2-4 parts of ferrous sulfate, 9-13 parts of potassium fulvate, 15-18 parts of decomposed cattle manure, 2-4 parts of withered persimmon leaves, 1-2 parts of sodium molybdate, 10-12 parts of wheat straw powder, 1-2 parts of oxidized graphene, 3-4 parts of fructooligosaccharides, 20-25 parts of waterborne polyurethane emulsion, 1-2 parts of an epoxy silane crosslinker and 4-5 parts of an assistant. According to the compound fertilizer, various raw materials are used; multiple nutritional ingredients are provided; the nutritional ingredients are coated with diatomite and a slow-release coating agent, so that the nutrient loss is hardly caused, the fertilizer efficiency lasts for a long time, the crop yield and the crop quality can be remarkably improved, and the planting benefit is relatively high.

Various devices are known in the art. However, their structure and means of operation are substantially different from the present disclosure. The present invention and its embodiments provide for a graphene/soil growing medium that promotes plant growth, increases water retention, and allows for nutrient loading. These and other objects, features, and advantages described in the present disclosure will be apparent to those skilled in the art from the following disclosure and description of exemplary embodiments.

At least one embodiment of this invention is presented in the drawings below and will be described in more detail herein.

### SUMMARY OF THE EMBODIMENTS

In general, the present invention and its embodiments provide for an improved growing medium incorporating single or few layer graphene, including graphene sheets, into the growing medium. In some instances, the growing medium may also incorporate some amount of graphene oxide. Such a growing medium has been shown to have a number of properties including, but not limited to, selectivity for aerobic bacteria, ability to load nutrients onto the graphene, loosening or aeration of the growing medium, pronounced root growth, and plant resistance to disease and insects.

Further, the growing medium may serve to more evenly disperse the temperatures (e.g. sunlight) as graphene's thermal conductivity is such that temperatures may be evenly dispersed through the medium. The growing medium may also serve as a molecular filter thereby helping to remove contaminants from the medium or surrounding water and prevent it from being absorbed into the plants via the root system.

In some instances, the growing medium may be interspersed with other mediums. For example, a stratification or layering between the growing medium described herein and clay or another material may be achieved. Such a layering may promote drainage, and increased root growth at particular stages, such as when the roots pass into each layer of the graphene containing medium.

In one embodiment of the present invention there is a growing medium which has a base material; and an additive comprising graphene and graphene oxide.

In another embodiment of the present invention there is a growing medium configured to render vegetation growth with an increased insect and disease resistance, the growing medium having a base material; an additive comprising graphene and graphene oxide, and wherein the graphene is loaded with at least one of sulfur or copper.

In yet another embodiment of the present invention there is a method of growing plants comprising the steps of loading graphene sheets with at least one of sulfur or copper; providing a base material; integrating the graphene sheets into the base material forming a growing medium. The method may further comprise the steps of providing a growth location; placing the growing medium into the growth location; and placing seeds or plants into the growing medium.

In general, the present invention succeeds in conferring the following, and others not mentioned, benefits and objectives.

It is an object of the present invention to provide a growing medium that is selective for aerobic bacteria.

It is an object of the present invention to provide a growing medium that provides loosening or aeration.

It is an object of the present invention to provide a growing medium that promotes pronounced root growth.

It is an object of the present invention to provide a growing medium that provides a time release nutrient mixture.

It is an object of the present invention to provide a growing medium that provides resulting foliage with an insect repellent characteristic.

It is an object of the present invention to provide a growing medium that provides for enhanced water retention.

It is an object of the present invention to provide a growing medium that promotes plant growth.

### BRIEF DESCRIPTION OF THE DRAWINGS

FIG. 1 illustrates a side-by-side comparison of a plant in a container utilizing an embodiment of the present invention, whereas the other plant is utilizing a conventional growing medium.

FIG. 2 illustrates another side-by-side comparison of a plant in a container utilizing an embodiment of the present invention, whereas the other plant is utilizing a conventional growing medium.

FIG. 3 illustrates a side view of plants in a container utilizing a conventional growing medium.

FIG. 4 illustrates a close-up view of a root structure of a plant growing in an embodiment of the present invention.

FIG. 5 illustrates a leaf of a corn plant that has been decimated (skeletonized) by Japanese beetles.

FIG. 6 illustrates a leaves of a corn plant that is growing in an embodiment of the present invention.

FIG. 7 illustrates a close-up view of a root structure of another plant growing in an embodiment of the present invention.

FIG. 8 illustrates a side view of a portion of a plant in a container utilizing a growing medium of the present invention.

FIG. 9 illustrates a side view of a portion of a plant in a container utilizing a growing medium of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

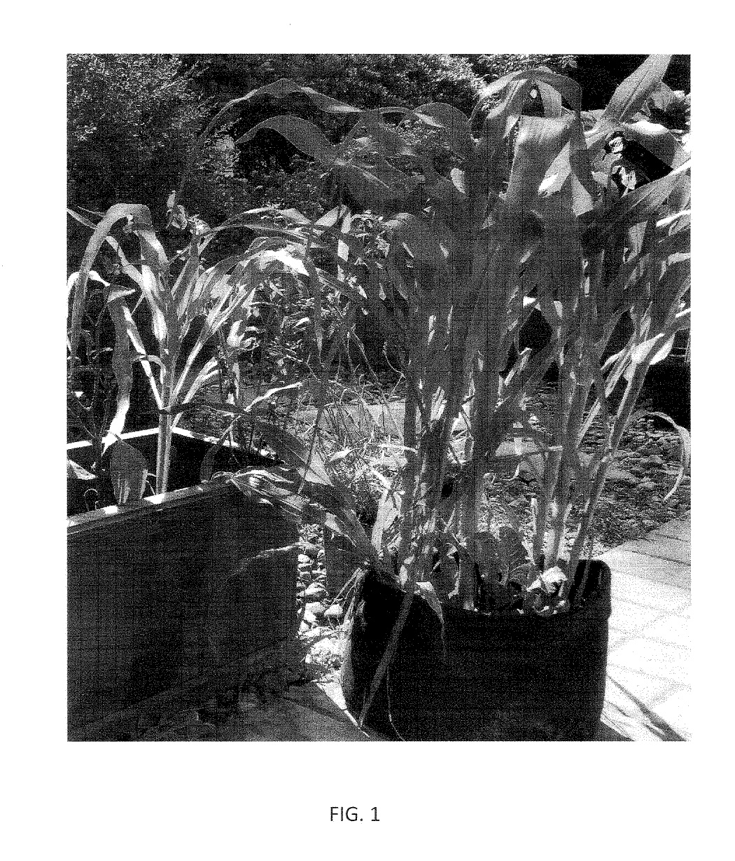

Referring now to FIG. 1, there is a side-by-side comparison of vegetation grown in the growing medium of the present invention and vegetation grown in a conventional or known growing medium. The vegetation grown in the conventional medium is on the left in the wooden box and the vegetation grown in the medium of the present invention is on the right in the black container. In this particular example, the vegetation is corn plants, however, the vegetation may be virtually any type of plant.

Here, the corn plants were purchased as seedlings having approximately the same characteristics in terms of exposed sunlight, watering, age, growing medium, etc. The black container was loaded with the medium of the present invention. In some embodiments, the growing medium may have about 1% to about 20% graphene (more preferably about 8%), about 1% to about 10% of graphene oxide (more preferably about 2%), and about 75% to about 99% conventional soil or potting soil or the like (more preferably about 90%). The other plant(s) in the wooden box were supplied with conventional soil (control) devoid of the additives, namely graphene/graphene oxide, of the present invention. The plants from each of the two containers have been exposed to the approximately same growing conditions save for the growing medium.

It can be seen from the images that the corn plants receiving the improved or enhanced growing medium (on right) have flourished in comparison to the plants receiving the traditional or known medium (on left). The plants receiving the medium of the present invention are taller, have better coloration, have more defined and pronounced root structure, as well as overall improved growth characteristics.

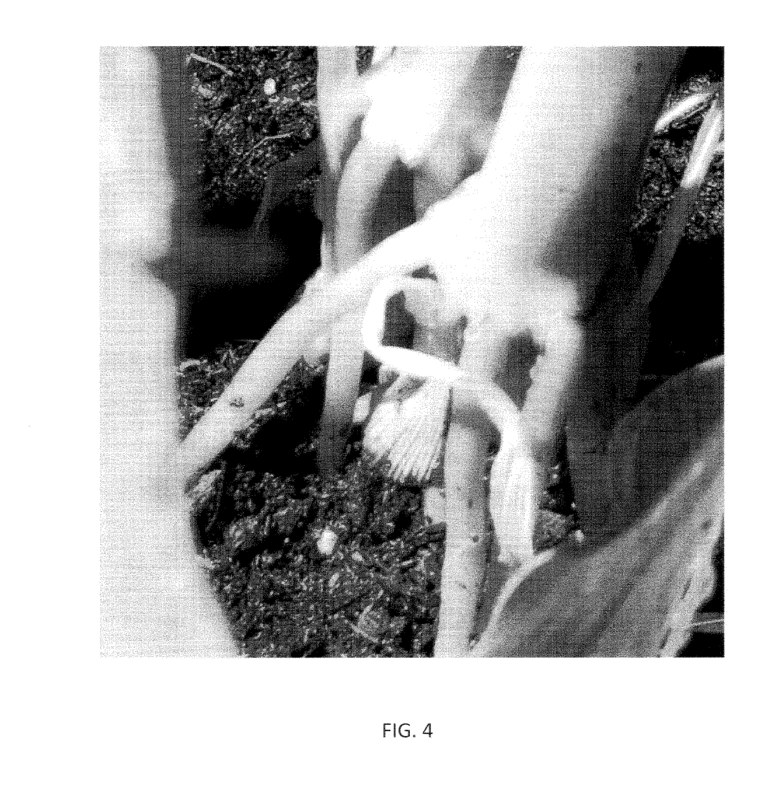

As shown in FIG. 4, there is a close up view of the pronounced root structure of the some of the corn plants shown in the growing medium of the present invention. Here, it can be seen that roots have taken hold nicely and are beginning to prominently form the nodal root system. In corn plants, emergence of the plants from seed does not equate to successful establishment of the plant. Nodal roots develop sequentially from individual nodes above the mesocotyl, beginning with the lowermost node in the area of the young seedling. This root system development greatly influences the overall health of the plant.

As is clearly shown, the nodal root system is abundant and prosperous. Not only have the corn plants grown at an improved rate compared to conventional methods and mediums, but the nodal root system, vital for success of the corn plant, has become established in a short amount of time thereby ensuring the longevity and health of the plant.

The reason for the growth seen by the corn plants as described above can be the result of a number of factors. For example, the growing medium of the present invention is generally soil with single or few layer graphene, including graphene sheets, interspersed or mixed with the soil. Further graphene oxide may be added in an amount of about 1% to about 10% and more preferably in an amount of about 2%.

The addition of the graphene imparts a number of properties to the growing medium. For example, the graphene oxide provides a source of oxygen which can be reduced by bacteria thereby providing for an environment that is selective towards healthy aerobic bacteria. Further, the graphene sheets may have nutrients loaded thereon including but not limited to nitrogen, potassium, phosphorous, sulfur, copper sulfate, or any combination thereof. This provides for enhanced amounts of these nutrients to be imparted into the growing medium and be released over time rather than all at once. Thus, the growing medium is capable of being a low maintenance, self-sustaining fertilizer. In other instances, the graphene may be mixed with other botanicals or insecticides (such as neem oil) or the like or some combination thereof.

The graphene will also allow for loosening or “aeration” of the soil into which it is mixed. This provides for promoting root growth, as the roots can easily pass through layers of the growing medium as well as water retention. Further, the growing medium may contain layering of differing materials. For example, there may be layers of graphene laden soil interspersed with layers of clay, loam, sand, etc. which will serve to promote plant growth in strategic stages. As the roots grow, the roots may hit a different layer (e.g. sand) causing the plant to slow in growth until the roots hit another graphene layer wherein the plant will begin to grow at a faster rate.

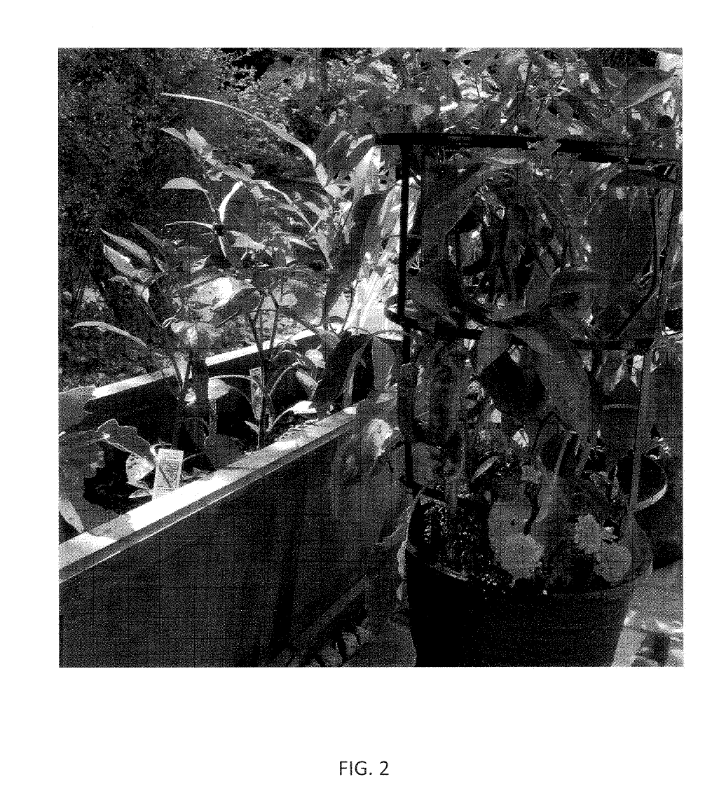

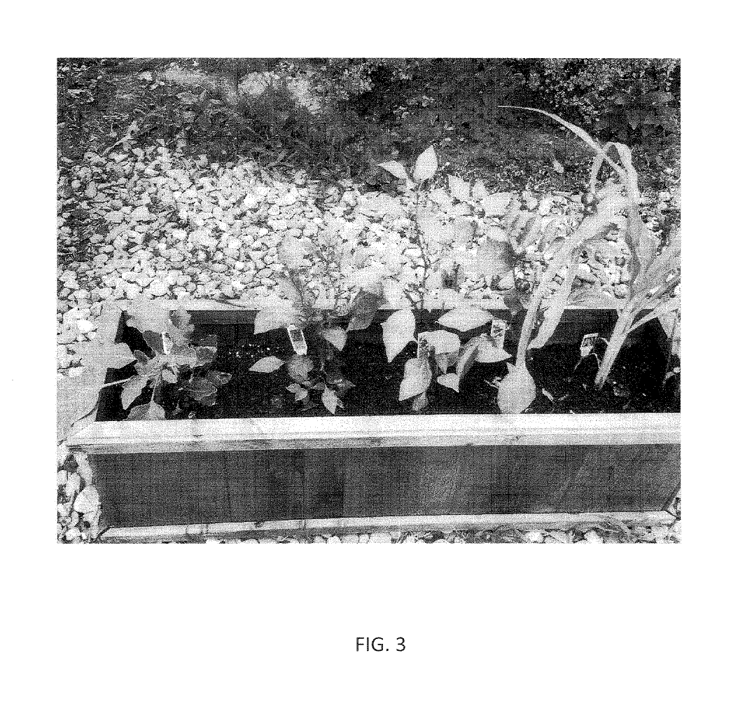

Referring now to FIGS. 2 and 3, there are additional comparative images showing plants utilizing a conventional growing medium and the enhanced medium of the present invention. In FIG. 2, there is another plant (hot pepper) being grown in the enhanced medium (on right) whereas another plant of the same variety is being grown in a conventional medium (on left). Again, the same comparisons and parameters can be applied to the plants, as was made to the corn plants in FIG. 1. Further, in FIG. 3, there is a side view of additional plants being grown in a conventional or traditional growing medium.

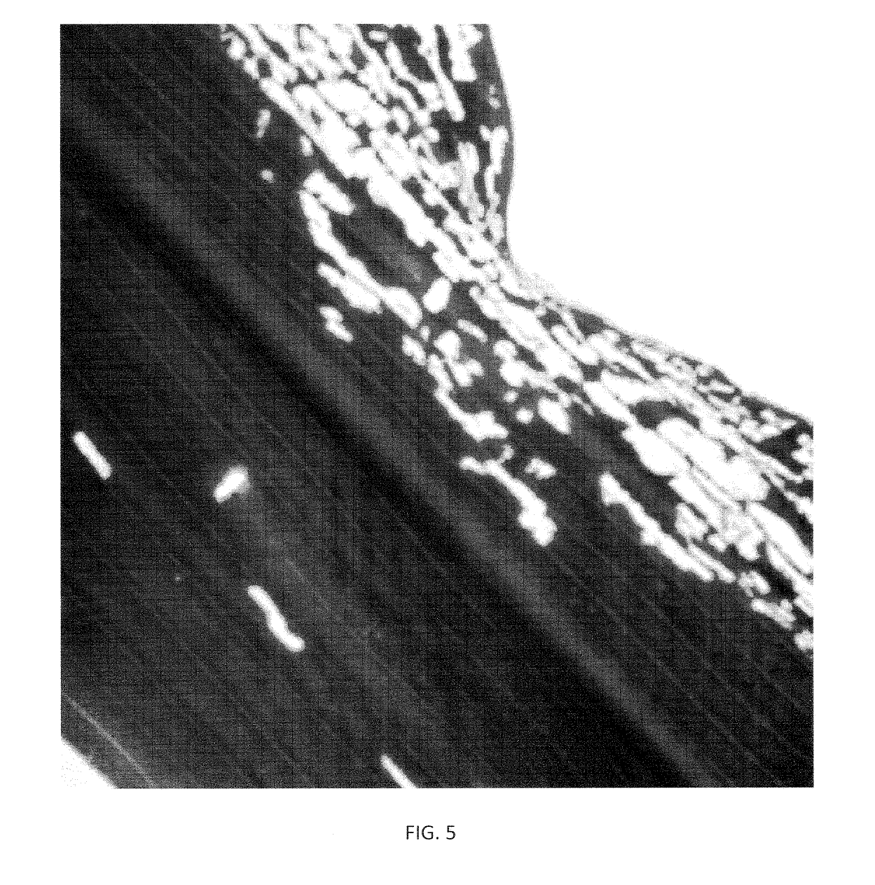

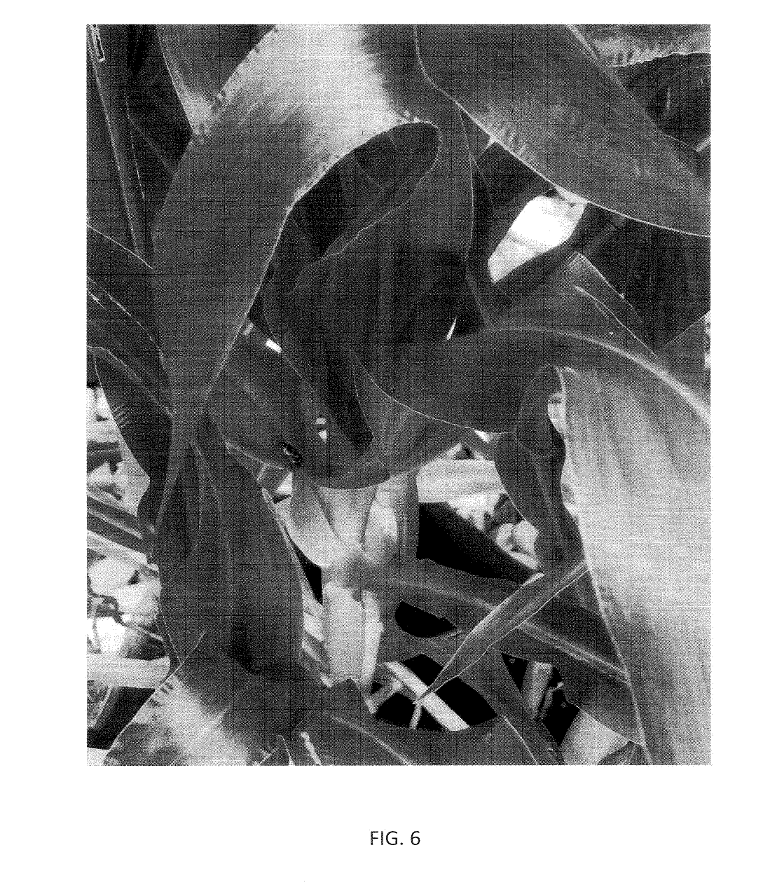

Referring now to FIGS. 5 and 6, there is a plant having been skeletonized by Japanese beetles and a plant unaffected by Japanese beetles respectively. Japanese beetles are known for their voracious appetites and their proclivity to damage plants by skeletonizing the foliage, that is, consuming only the leaf material between the veins. The Japanese beetles may also feed on fruit on the plants if present. FIG. 5 demonstrates the destructive nature of the beetles, as this corn leaf has been skeletonized by the beetles. The present invention and its embodiments has been shown to prevent or limit such skeletonizing as shown in FIG. 6.

As shown in FIG. 6, there is a corn plant being grown in the growing medium of the present invention. The corn plant exhibits all of the traits discussed herein grown in said medium. However, usually plants must be sprayed, particularly those that are attractive to destructive insects, to prevent plant damage. The plant shown in FIG. 6 has not been treated for Japanese beetles. The incidence of beetles on the plant is dramatically decreased, and while a Japanese beetle is shown on the plant, the plant does not appear to have been skeletonized.

As such, the present invention and its embodiments may have a particular use for boosting or incorporating properties into a plant that act as natural insecticides, repellents, or boosts plant immunity. As Japanese beetles prefer at least the following plants: beans, strawberries, tomatoes, peppers, grapes, hops, roses, cherries, plums, pears, peaches, raspberries, blackberries, corn, peas, birch trees, linden trees, and blueberries, the present invention and its embodiments may serve a particular use to these plant in preventing such damage.

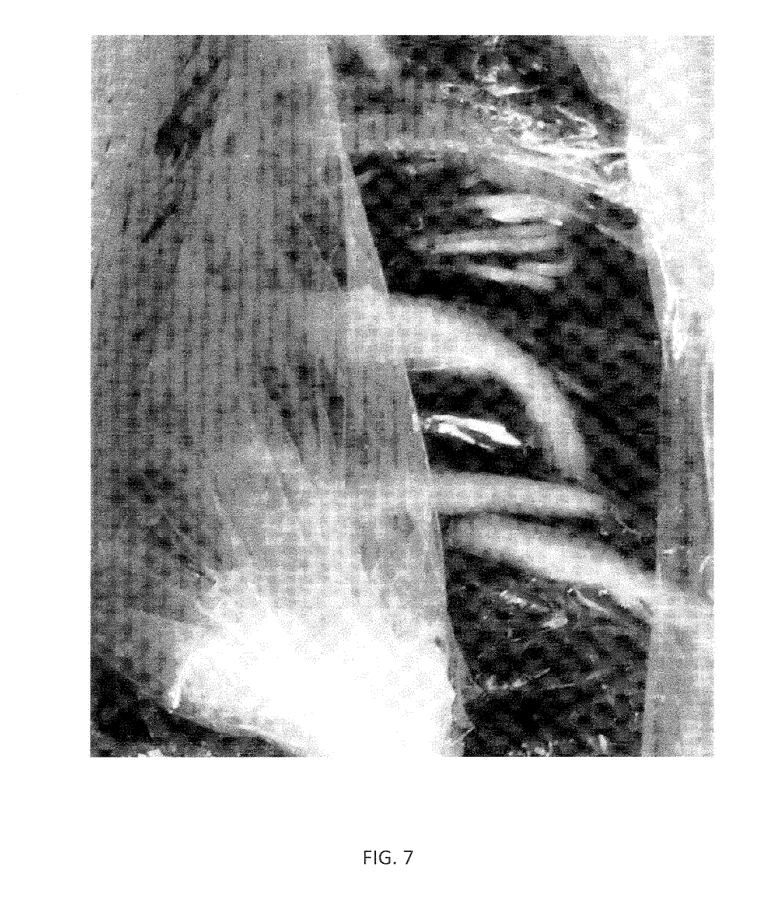

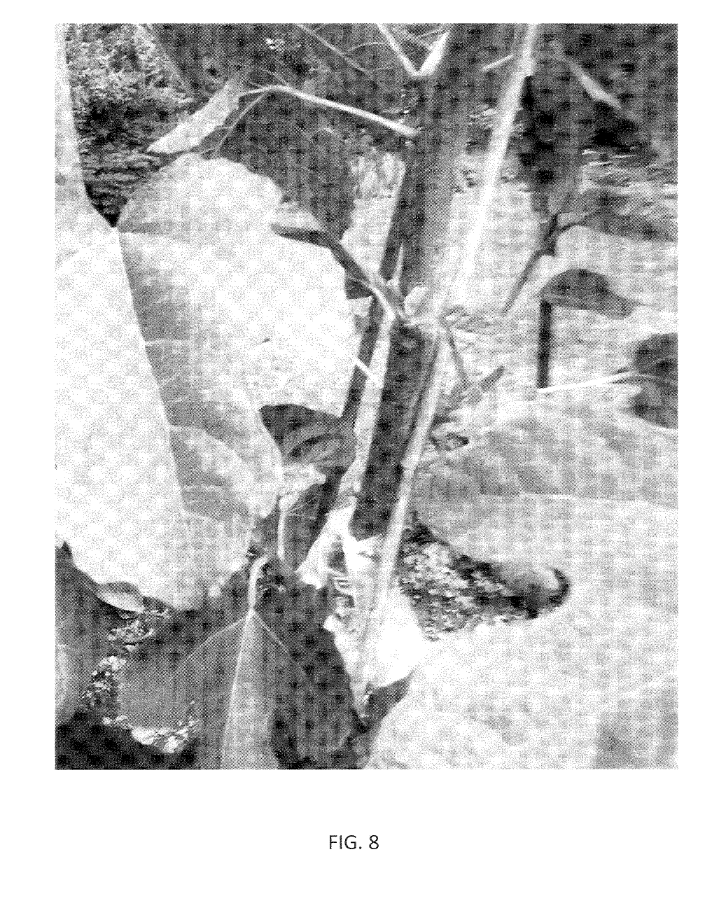

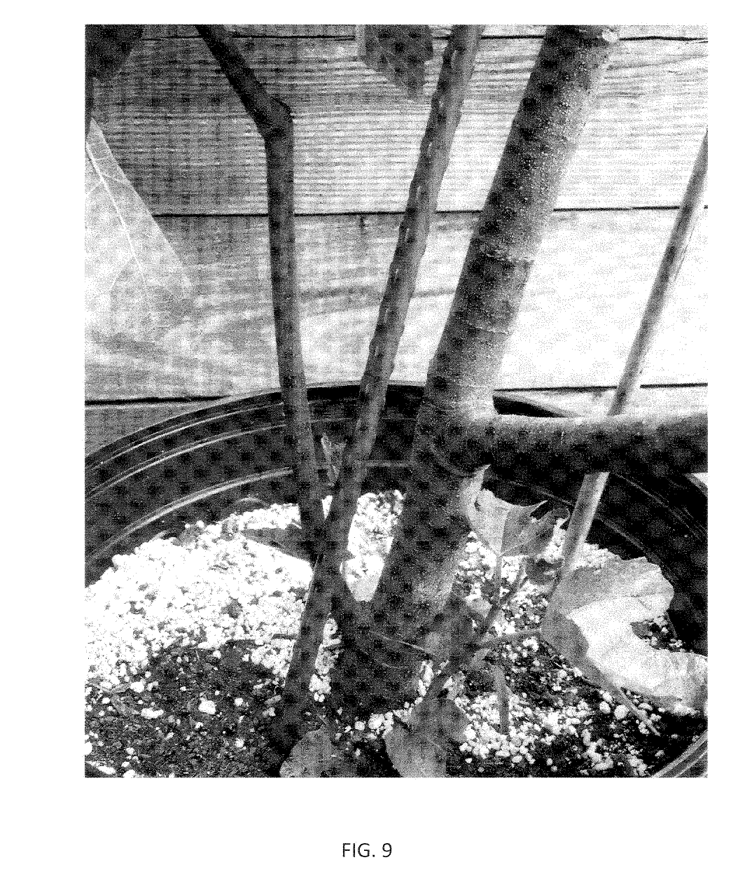

Referring now to FIGS. 7-9, there are multiple views of another plant, a fig tree, being grown in the growing medium of the present invention. In FIG. 7, the root growth is visible, and after only a short growth duration, the roots are bulging from the main trunk portion of the growth. In addition, FIGS. 8-9 demonstrate healthy growth on the remainder of the plant. FIG. 8 shows some of the foliage and the large, lobed trees commonly associated with healthy fig trees. The foliage is also free of pests and other blights. Further, in FIG. 9, the trunk is shown to be sturdy and healthy. There are no splits or signs of damage from the environment or parasites. The growing medium has shown to produce healthy vibrant vegetation.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A growing medium comprising:
a base material; and
an additive comprising graphene or graphene oxide or a combination thereof.

2. The medium of claim 1 wherein the graphene oxide is present in a range of about 1% to about 10%.

3. The medium of claim 1 wherein the graphene oxide is present in an amount of about 2%.

4. The medium of claim 1 wherein the base material is soil.

5. The medium of claim 1 wherein the graphene is saturated with at least one nutrient.

6. The medium of claim 5 wherein the at least one nutrient is nitrogen, potassium, phosphorous, sulfur, copper sulfate, or any combination thereof.

7. The medium of claim 5 wherein the at least one nutrient is configured to be released gradually over a first time period.

8. The medium of claim 1 wherein the medium promotes pronounced root growth.

9. The medium of claim 1 wherein the medium enhances plant growth.

10. A growing medium to render vegetation growth with an increased insect and disease resistance, the growing medium comprising:
a base material; and
an additive comprising graphene or graphene oxide or a combination thereof, wherein the graphene is loaded with at least one of sulfur or copper.

11. A method of growing plants comprising:
loading graphene with at least one of sulfur or copper;
providing a base material;
integrating the graphene into the base material forming a growing medium.

12. The method of claim 11 further comprising the steps of:
providing a growth location;
placing the growing medium into the growth location; and
placing seeds or plants into the growing medium.

13. The method of claim 11 further comprising the step of:
integrating graphene oxide into the growing medium.

14. The method of claim 13 wherein an amount of graphene oxide is present in about 1% to about 10%.

15. The method of claim 14 wherein the amount of graphene oxide is about 2%.

16. The medium of claim 1 wherein the graphene is present in a range of about 1% to about 20%.

17. The medium of claim 1 wherein the base material is present in a range of about 75% to about 99%.

18. The medium of claim 1 wherein the amount of graphene is about 8%.
